(19) United States
(12) Patent Application Publication
(10) Pub. No.: US 2013/0082206 A1
(43) Pub. Date: Apr. 4, 2013

(54) LIQUID CRYSTAL POLYESTER COMPOSITION

(71) Applicant: Sumitomo Chemical Company, Limited, Tokyo (JP)

(72) Inventors: Yoshiyuki FUKUHARA, Namerikawa-shi (JP); Shintaro KOMATSU, Tsukuba-shi (JP)

(73) Assignee: SUMITOMO CHEMICAL COMPANY, LIMITED, Tokyo (JP)

(21) Appl. No.: 13/624,344

(22) Filed: Sep. 21, 2012

(30) Foreign Application Priority Data
Sep. 29, 2011 (JP) 2011-214341

(51) Int. Cl. C09K 19/54

(52) U.S. Cl. 252/299.5

(57) ABSTRACT

The invention intends to provide a connector high in resistance to rupture of a lattice and a liquid crystal polyester composition superior in melt flowability and suitable for the production of the connector. The invention provides a liquid crystal polyester composition comprising a fibrous filler, a platy filler, a granular filler, and a liquid crystal polyester, wherein the content of the platy filler is not more than 0.6 where the total content (based on mass) of the fibrous filler and the granular filler is considered to be 1; and a connector made of the liquid crystal polyester composition.

### BACKGROUND OF THE INVENTION

1. Field of the Invention

The present invention relates to liquid crystal polyester compositions and connectors made of the compositions.

2. Description of the Related Art

As a connector for electronic components, for example, there is known a CPU socket for detachably mounting a CPU (central processing unit) to an electronic circuit board. Such a CPU socket is usually made of a resin superior in heat resistance, etc.

As an electronic equipment with high performance has been developed, the scale of a circuit of CPU to be mounted on an electronic circuit board has increased. Generally, as the scale of a CPU increases, the number of contact pins increases. Recently, CPUs including about 700 to 1,000 contact pins have been known. The contact pins of a CPU are disposed on a bottom face of the CPU, for example, in a matrix form. A pitch of these contact pins tends to decrease as the number of the contact pins increases. Also, as the scale of an IC increases, a calorific value tends to increase.

A CPU socket has a number of pin insertion holes corresponding to individual contact pins of a CPU, the holes forming a lattice. As the pitch of the contact pins decreases, the pitch of the pin insertion holes decreases and therefore, the thickness of the resin partitioning the pin insertion holes, namely, the wall of the lattice decreases. Therefore, in CPU sockets, as the number of pin insertion holes increases, rupture of a lattice is likely to be caused by reflow soldering or pin insertion.

Although CPU sockets are generally produced by using injection molding, if the wall of a lattice is thin, partial incomplete filling (i.e., a phenomenon of lacking the filled amount of resin) is likely to occur when the resin is filled into a mold. At the portion where incomplete filling has occurred, mechanical strength becomes insufficient. In order to suppress the occurrence of such incomplete filling, it is necessary to cause a resin composition for molding to have sufficiently high melt flowability.

Thus, as for connectors for electronic components such as CPU sockets, it is required to increase the melt flowability of a resin composition at the time of molding and also improve resistance to the rupture of a lattice after the molding.

JP-A-2005-276758 has disclosed a method for producing a connector using a resin composition prepared by incorporating a fibrous filler into a liquid crystal polymer and improved in melt flowability (see, for example, paragraph [0088]).

JP-A-8-325446 has disclosed obtaining a connector improved in mechanical strength, etc. by molding a resin composition prepared by filling a liquid crystal polyester resin with glass beads (see paragraph [0038], etc.).

JP-A-2006-274068 has disclosed obtaining a connector with suppressed blister or the like upon reflow soldering by molding a resin composition prepared by incorporating a scaly reinforcement or a scaly reinforcement and a fibrous reinforcement (see paragraph [0011], etc.).

However, the connectors (CPU sockets) disclosed in JP-A-2005-276758, JP-A-8-325446, and JP-A-2006-274068 have a problem that incomplete filling of a resin composition at the time of molding and the rupture of a lattice after molding cannot be suppressed sufficiently when there are many pin insertion holes and a wall of a lattice is thin.

### SUMMARY OF THE INVENTION

The present invention was devised in view of the above-mentioned situation and the object thereof is to provide a connector high in resistance to the rupture of a lattice and also provide a liquid crystal polyester composition superior in melt flowability and suitable for the production of the connector.

The present invention is a liquid crystal polyester composition comprising a fibrous filler, a platy filler, a granular filler, and a liquid crystal polyester, wherein the content of the platy filler is not more than 0.6 where the combined content (based on mass) of the fibrous filler and the granular filler is considered to be 1.

In the liquid crystal polyester composition of the present invention, it is preferred that the combined content of the fibrous filler, the platy filler, and the granular filler is not more than 50% by mass where the overall amount of the liquid crystal polyester composition is considered to be 100% by mass.

In the liquid crystal polyester composition of the present invention, it is preferred that the content of the fibrous filler is 5 to 80 parts by mass where the content of the liquid crystal polyester is considered to be 100 parts by mass.

In the liquid crystal polyester composition of the present invention, it is preferred that the content of the platy filler is 5 to 80 parts by mass where the content of the liquid crystal polyester is considered to be 100 parts by mass.

In the liquid crystal polyester composition of the present invention, it is preferred that the content of the granular filler is 5 to 80 parts by mass where the content of the liquid crystal polyester is considered to be 100 parts by mass.

In the liquid crystal polyester composition of the present invention, it is preferred that the average fiber diameter of the fibrous filler is 5 to 20 μm and the number average fiber length of the fibrous filler is not less than 100 μm.

In the liquid crystal polyester composition of the present invention, it is preferred that the volume average particle diameter of the platy filler is 10 to 100 μm.

In the liquid crystal polyester composition of the present invention, it is preferred that the volume average particle diameter of the granular filler is 10 to 100 μm.

In the liquid crystal polyester composition of the present invention, it is preferred that the liquid crystal polyester contains repeating units represented by the following formula (A1) in an amount of not less than 30 mol % where the overall amount of all repeating units constituting the liquid crystal polyester is considered to be 100 mol %:

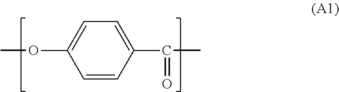

The present invention also provides a connector made of the above-mentioned liquid crystal polyester composition of the present invention.

According to the present invention, it is possible to provide a connector high in resistance to the rupture of a lattice and a liquid crystal polyester composition superior in melt flowability and suitable for the production of the connector.

### BRIEF DESCRIPTION OF THE DRAWINGS

FIG. 1 is a schematic view illustrating a connector according to the present invention; (a) is a plan view and (b) is a sectional view taken along the A-A line of (a); and

FIG. 2 is a schematic view illustrating a connector according to the present invention, which is an enlarged view of region B in FIG. 1(a).

### DETAILED DESCRIPTION OF THE PREFERRED EMBODIMENTS

The liquid crystal polyester composition of the present invention is superior in melt flowability at the time of molding and suitable for the production of a connector high in resistance to the rupture of a lattice after molding. Regarding a lattice of a connector, “high in resistance to rupture” means that the lattice is less likely to be cracked or bent when an external force is applied and it is high in mechanical strength.

The liquid crystal polyester composition of the present invention exerts its superior effects due to the above-described setting of the contents of the respective fillers. For example, a liquid crystal polyester composition containing only a fibrous filler as a filler has insufficient melt flowability and therefore it is likely to cause incomplete filling at the time of molding. On the other hand, a liquid crystal polyester composition containing only a platy filler as a filler is less likely to cause incomplete filling at the time of molding, but it shrinks easily and therefore a lattice of its molded article (connector) is likely to break or warp. A liquid crystal polyester composition containing only a fibrous filler and a platy filler as fillers is less likely to cause incomplete filling in molding or warpage, but a lattice of its molded article is likely to break.

The liquid crystal polyester according to the present invention is a thermotropic liquid crystal polymer and forms an anisotropy melt at temperatures of up to 400° C. Preferably, it is prepared by polymerizing feed monomers such as an aromatic hydroxycarboxylic acid, an aromatic dicarboxylic acid, and an aromatic diol.

In order to prepare a liquid crystal polyester more easily, it is also possible to convert the feed monomers such as an aromatic hydroxycarboxylic acid, an aromatic dicarboxylic acid and an aromatic diol partly into ester-forming derivatives thereof and then perform polymerization using the same.

Examples of such ester-forming derivatives include those prepared by converting carboxyl groups of an aromatic hydroxycarboxylic acid and an aromatic dicarboxylic acid into highly reactive groups such as an acid halide group and an acid anhydride group, and those prepared by converting carboxyl groups into esters capable of forming a polyester by a transesterification reaction.

Further examples of such ester-forming derivatives include those prepared by converting phenolic hydroxyl groups of an aromatic hydroxycarboxylic acid and an aromatic diol into esters capable of forming a polyester by a transesterification reaction.

The repeating units of the liquid crystal polyester according to the present invention are described below by taking specific examples.

Examples of a repeating unit derived from an aromatic hydroxycarboxylic acid include repeating units (A1) to (A4) represented by the following formulae.

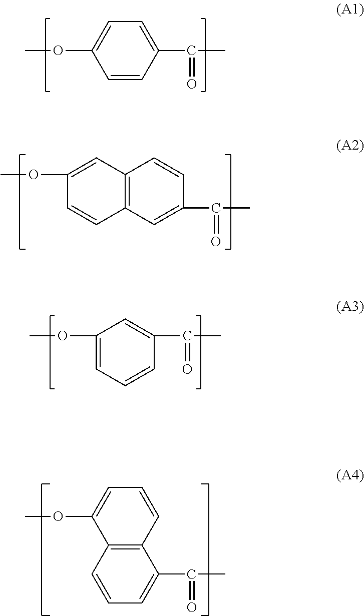

Examples of a repeating unit derived from an aromatic dicarboxylic acid include repeating units (B1) to (B4) represented by the following formulae.

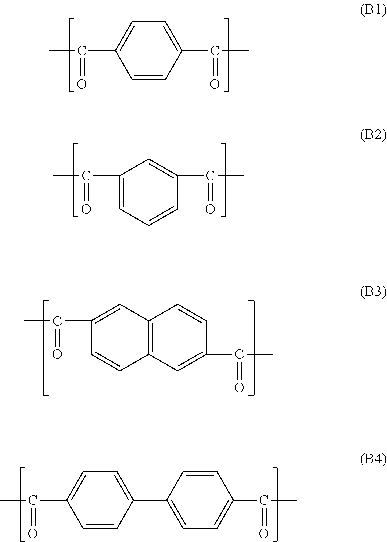

Examples of a repeating unit derived from an aromatic diol include repeating units (C1) to (C4) represented by the following formulae.

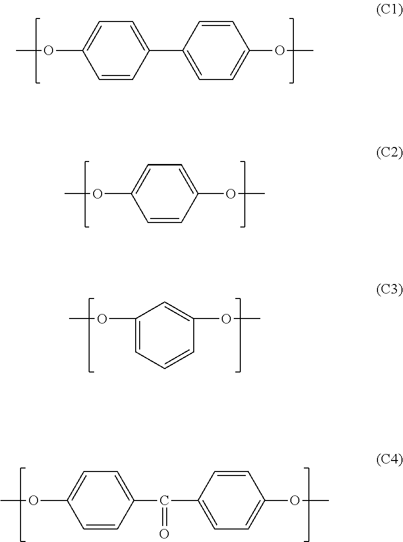

In each of the repeating units (A1) to (A4), (B1) to (B4), and (C1) to (C4), some hydrogen atoms in the aromatic ring may have been substituted with at least one substituent selected from the group consisting of a halogen atom, an alkyl group, and an aryl group.

Examples of the halogen atom include a fluorine atom, a chlorine atom, and a bromine atom.

The alkyl group is preferably linear or branched and more preferably linear and examples thereof include lower alkyl groups having 1 to 4 carbon atoms, such as a methyl group, an ethyl group, a n-propyl group, and a n-butyl group.

The aryl group may be either monocyclic or polycyclic, but it is preferably monocyclic and examples thereof include a phenyl group.

Desirably, the liquid crystal polyester according to the present invention has the aforementioned repeating units in any one of the following combinations [a] through [d]:

[a] the combination of repeating units (A1) and/or (A2), repeating units (B1) and/or (B2), and repeating units (C1) and/or (C2);

[b] the combination of a repeating unit (A1) and a repeating unit (A2);

[c] the combination resulting from the replacement of part of (B1) or (B2) by (B3) in the above combination [a]; and

[d] the combination resulting from the replacement of part of (C1) or (C2) by (C3) in the above combination [a].

Among these, particularly preferred is a liquid crystal polyester composed of the combination of a repeating unit derived from p-hydroxybenzoic acid and/or a repeating unit derived from 6-hydroxy-2-naphthoic acid (corresponding to repeating unit (A1) and/or (A2)), a repeating unit derived from terephthalic acid and/or a repeating unit derived from isophthalic acid (corresponding to repeating unit (B1) and/or (B2)), and a repeating unit derived from 4,4′-dihydroxybiphenyl and/or a repeating unit derived from hydroquinone (corresponding to repeating unit (C1) and/or (C2)), which corresponds to the combination [a].

Moreover, as to the molar proportions of the repeating units in this combination, {repeating unit (C1)+repeating unit (C2)}/{repeating unit (A1)+repeating unit (A2)} is preferably adjusted to 0.2 to 1, and {repeating unit (B1)+repeating unit (B2)}/{repeating unit (C1)+repeating unit (C2)} is preferably adjusted to 0.9 to 1.1. Moreover, repeating unit (B2)/repeating unit (B1) is preferably adjusted to be larger than 0 and not larger than 1, more preferably adjusted to be larger than 0 and not larger than 0.7. Furthermore, repeating unit (C2)/repeating unit (C1) is preferably adjusted to be larger than 0 and not larger than 1, more preferably adjusted to be larger than 0 and not larger than 0.3.

The liquid crystal polyester according to the present invention preferably has the repeating unit (A1) in an amount of 30 mol % or more based on the overall amount of all the repeating units constituting the liquid crystal polyester and more preferably has the repeating unit (A1) in an amount of 30 mol % or more based on the overall amount of all the repeating units constituting the liquid crystal polyester in the aforementioned combinations [a] through [d].

Preferably, the liquid crystal polyester according to the present invention is produced, for example, by a method comprising the below-described acylation step and polymerization step:

[Acylation step] a step of acylating a phenolic hydroxyl group of an aromatic diol and/or an aromatic hydroxycarboxylic acid with a fatty acid anhydride (e.g., acetic anhydride) to obtain an acylated product (i.e., an acylated aromatic diol and/or an acylated aromatic hydroxycarboxylic acid); and

[Polymerization step] a step of polymerizing acyl groups of the acylated product obtained in the acylation step with carboxyl groups of an acylated product of an aromatic dicarboxylic acid and/or an aromatic hydroxycarboxylic acid by a transesterification reaction to obtain a liquid crystal polyester.

The acylation step and the polymerization step may be conducted in the presence of a heterocyclic organic base compound represented by the following formula (I):

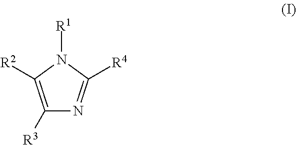

wherein, R¹ to R⁴ each independently represent a hydrogen atom, an alkyl group having 1 to 4 carbon atoms, a hydroxymethyl group, a cyano group, a cyanoalkyl group whose alkyl group has 1 to 4 carbon atoms, a cyanoalkoxy group whose alkoxy group has 1 to 4 carbon atoms, a carboxyl group, an amino group, an aminoalkyl group having 1 to 4 carbon atoms, an aminoalkoxy group having 1 to 4 carbon atoms, a phenyl group, a benzyl group, a phenylpropyl group, or a formyl group.

As the aforementioned heterocyclic organic base compound, 1-methylimidazole and/or 1-ethylimidazole are particularly preferred due to their ready availability.

Preferably, the use amount of the heterocyclic organic base compound is adjusted to within the range of from 0.005 to 1 part by mass where the total use amount of the feed monomers (e.g., an aromatic hydroxycarboxylic acid, an aromatic dicarboxylic acid, and an aromatic diol) of the liquid crystal polyester is considered to be 100 parts by mass. More preferably, from the viewpoints of the color tone and productivity of a molded article (connector) described below, the use amount of the heterocyclic organic base compound is adjusted to within the range of from 0.05 to 0.5 parts by mass based on 100 parts by mass of the total use amount of the feed monomers.

Such a heterocyclic organic base compound is just required to be present at least temporarily during the acylation reaction and the transesterification reaction, and it may be added immediately before the initiation of the acylation reaction, during the acylation reaction, or between the acylation reaction and the transesterification reaction.

The liquid crystal polyester thus obtained is advantageous in that its melt flowability is very high.

The use amount of the fatty acid anhydride (for example, acetic anhydride) should be determined taking the use amount of the feed monomers, i.e., the aromatic diol and/or the aromatic hydroxycarboxylic acid into consideration. Specifically, the use amount of the fatty acid anhydride is preferably adjusted to 1 to 1.2 equivalents, more preferably 1 to 1.15 equivalents, even more preferably 1.03 to 1.12 equivalents, and particularly preferably 1.05 to 1.1 equivalents based on the overall amount of the phenolic hydroxyl groups contained in the feed monomers.

The acylation reaction in the acylation step is preferably conducted at a temperature of 130 to 180° C. for a period of 30 minutes to 20 hours, and more preferably conducted at a temperature of 140 to 160° C. for a period of 30 minutes to 5 hours.

The aromatic dicarboxylic acid to be used in the polymerization step may be present in the reaction system during the acylation step. Namely, in the acylation step, an aromatic diol, an aromatic hydroxycarboxylic acid and an aromatic dicarboxylic acid may be present in the same reaction system. This is because both carboxyl groups and substituents optionally substituting for hydrogen atoms in the aromatic dicarboxylic acid are not influenced by fatty acid anhydrides. Therefore, it is possible to use a method in which the acylation step and the polymerization step are sequentially conducted after charging an aromatic diol, an aromatic hydroxycarboxylic acid and an aromatic dicarboxylic acid in a reactor, or a method in which an aromatic diol and an aromatic dicarboxylic acid are charged in a reactor and, after conducting the acylation step, an aromatic dicarboxylic acid is further charged in the reactor and the polymerization step is conducted. From the viewpoint of simplification of the production process, the former method is preferred.

The transesterification reaction in the polymerization step is preferably carried out with temperature elevation at a rate of 0.1 to 50° C./minute from a starting temperature of 130 to 160° C. to a stopping temperature of 300 to 400° C. It is more preferable to carry out the reaction with temperature elevation at a rate of 0.3 to 5° C./minute from a starting temperature of 140 to 160° C. to a stopping temperature of 310 to 400° C.

When the transesterification reaction of the polymerization step is conducted, a fatty acid produced as a by-product (for example, acetic acid) and the unreacted fatty acid anhydride (for example, acetic anhydride) are preferably distilled out of the system by evaporation so as to shift equilibrium by the Le Chatelier-Brown's principle (the principle of equilibrium shift). At this time, feed monomers evaporated and sublimated together with the fatty acid can also be returned to the reactor after condensation or anti-sublimation by refluxing a portion of the fatty acid distilled out and returning to the reactor.

In the acylation reaction of the acylation step and the transesterification reaction of the polymerization step, a batch apparatus may be used or a continuous apparatus may be used as the reactor. It is possible to obtain a liquid crystal polyester which can be used in the present invention even if any of the reaction apparatuses is used.

After the polymerization step, a step of increasing the molecular weight of the liquid crystal polyester obtained in the polymerization step may be conducted. For example, it is possible to increase the molecular weight when a powdery liquid crystal polyester is prepared by cooling and crushing the liquid crystal polyester obtained in the polymerization step, and then the powder is heated. It is also possible to increase the molecular weight by granulating a powdery liquid crystal polyester obtained by cooling and crushing to prepare a pelletized liquid crystal polyester, and heating the pelletized liquid crystal polyester. The process of increasing the molecular weight using such a method is called solid phase polymerization in the art. The solid phase polymerization is particularly effective as the method of increasing the molecular weight of a liquid crystal polyester. It is easy to obtain a liquid crystal polyester having a preferred flow onset temperature described below by increasing the molecular weight of a liquid crystal polyester. A heat treatment in the case of the solid phase polymerization is preferably conducted under an inert gas (for example, nitrogen gas) atmosphere or under reduced pressure, and the heating time is preferably adjusted to within the range of from 1 to 20 hours. Examples of the apparatus to be used for the heat treatment include known dryers, reactors, inert ovens, mixers, and electric furnaces.

The flow onset temperature of the liquid crystal polyester according to the present embodiment is preferably from 270° C. to 400° C., and more preferably from 280° C. to 380° C. That is, when the flow onset temperature is within such a range, the melt flowability of the liquid crystal polyester composition is improved more, and also heat resistance (e.g., solder resistance in the case where a molded body is an electronic component such as a socket) is improved more. In addition, thermal degradation is suppressed more during melt molding in the production of a molded article from the liquid crystal polyester.

The flow onset temperature is also called a flow temperature and that is a temperature at which a liquid crystal polyester exhibits a viscosity of 4800 Pa·s (48000 Poise) when being molten by increasing the temperature thereof at a rate of 4° C./min under a load of 9.8 MPa (100 kg/cm²) by using a capillary rheometer and then extruded through a nozzle being 1 mm in inner diameter and 10 mm in length. The flow onset temperature can be used as a measure of the molecular weight of a liquid crystal polyester (see “Liquid Crystal Polymer—Synthesis, Molding, and Application—” edited by Naoyuki Koide, p. 95, CMC, published on Jun. 5, 1987).

As to the liquid crystal polyester according to the present invention, only one species may be used or two or more species may be used in combination. When two or more species are used together, their combination and proportions can be determined arbitrarily.

The fibrous filler according to the present invention is not particularly restricted and examples thereof include glass fiber, silica alumina fiber, alumina fiber, and carbon fiber.

As the fibrous filler, one having an average fiber diameter of 5 to 20 μm and an a average aspect ratio larger than 20 (namely, one having a number average fiber length of not less than 100 μm) is preferred. The fact that the average aspect ratio is 20 or more leads to a high effect of suppressing the rupture of a lattice at a weld portion (i.e., a linear scar generated at a position where two or more flow fronts have met when a resin composition was injected into a mold) to be formed during molding.

For example, the number average fiber length of the fibrous filler can be measured by the following method. That is, 1 g of pellets of a liquid crystal polyester composition containing a filler is put into a crucible and then ashed in an electric furnace of 600° C. Then, 10 mg of the resulting ash and 1.5 ml of ethylene glycol are put into a 3.5-ml screw tube and dispersed for 1 minute using an ultrasonic cleaner (e.g., a product manufactured by VELVO CLEAR). The resulting dispersion liquid is suck up with a syringe or the like. One drop thereof is dropped onto a slide glass and then observed with a video microscope (e.g., “VHX-1000” manufactured by KEYENCE CORP.) in a field of view of 100 magnifications. Fiber length is measured for 300 fibers and a number average fiber length is calculated from the measurements.

The content of the fibrous filler in the liquid crystal polyester composition of the present invention is preferably 5 to 80 parts by mass, more preferably 10 to 50 parts by mass based on 100 parts by mass of the liquid crystal polyester. By adjusting the content to 5 parts by mass or more, the resistance of a molded article to warpage or the rupture of a lattice is improved even if the molded article is thin. On the other hand, by adjusting the content to 80 parts by mass or less, the melt flowability, extrudability, and moldability of the liquid crystal polyester composition are improved and therefore incomplete filling is suppressed more, so that the mechanical strength of molded articles is more improved.

The platy filler is not particularly restricted and examples thereof include talc, mica, and graphite. Talc and mica are preferred.

The volume average particle diameter of the platy filler is preferably 5 μm or more, and more preferably 10 to 100 μm. By adjusting the volume average particle diameter to 5 μm or more, it is possible to sufficiently suppress the orientation inherent to liquid crystal polyesters and also possible to reduce the warpage of molded articles more. By adjusting it to 100 μm or less, the flowability of the liquid crystal polyester composition is increased.

The volume average particle diameter of the platy filler is determined by the laser diffraction method under the following measurement conditions.

Measuring instrument: Mastersizer 2000 (Malvern Instruments Ltd.)

Index of refraction of particle: 1.65-0.1i

Dispersing medium: water

Index of refraction of dispersing medium: 1.33

Analysis model: General purpose

Obscuration: 5 to 7%

The content of the platy filler in the liquid crystal polyester composition of the present invention is preferably 5 to 80 parts by mass, more preferably 20 to 70 parts by mass based on 100 parts by mass of the liquid crystal polyester. By adjusting the content to 5 parts by mass or more, the resistance of a molded article to warpage or rupture of a lattice is improved even if the molded article is thin. On the other hand, by adjusting the content to 80 parts by mass or less, the melt flowability, extrudability, and moldability of the liquid crystal polyester composition are improved and therefore incomplete filling is suppressed more, so that the mechanical strength of molded articles is more improved.

The aforementioned granular filler is not particularly restricted, and examples thereof include glass beads and glass balloons. The granular filler is preferably one in a spherical shape, and glass beads, glass balloons, etc. are particularly preferred.

The volume average particle diameter of the granular filler is preferably 5 μm or more, and more preferably 10 to 100 μm. By adjusting the volume average particle diameter to 5 μm or more, it is possible to sufficiently suppress the orientation inherent to liquid crystal polyesters and also possible to reduce the warpage of molded articles more. By adjusting it to 100 μm or less, the flowability of the liquid crystal polyester composition is increased.

The volume average particle diameter of the granular filler is determined by the same method as that used in the case of the aforementioned platy filler.

The content of the granular filler in the liquid crystal polyester composition of the present invention is preferably 5 to 80 parts by mass, more preferably 10 to 70 parts by mass based on 100 parts by mass of the liquid crystal polyester. By adjusting the content to 5 parts by mass or more, the resistance of a molded article to warpage or the rupture of a lattice is improved even if the molded article is thin. On the other hand, by adjusting the content to 80 parts by mass or less, the melt flowability, extrudability, and moldability of the liquid crystal polyester composition are improved and therefore incomplete filling is suppressed more, so that the mechanical strength of molded articles is more improved.

The mass ratio of the content of the platy filler to the combined content of the fibrous filler and the granular filler in the liquid crystal polyester composition of the present invention ([the content (mass) of the platy filler]/{[the content (mass) of the fibrous filler]+[the content (mass) of the granular filler]}) is 0.6 or less; by adjusting the ratio to such a range, especially the mechanical strength of molded article is improved.

Preferably, the combined content of the fibrous filler, the platy filler, and the granular filler in the liquid crystal polyester composition of the present invention is not more than 50% by mass where the overall amount of the liquid crystal polyester composition is considered to be 100% by mass. By adjusting the combined content to such a range, the melt flowability, the extrudability, and the moldability of the liquid crystal polyester composition are improved, so that incomplete fill is suppressed more.

As to each of the fibrous filler, platy filler, and granular filler according to the present invention, one species may be used alone or two or more species may be used in combination. When two or more species are used together, their combination and proportions can be determined according to the intended purpose.

Unless the effect of the present invention is impaired, the liquid crystal polyester composition of the present invention may contain other components that correspond to none of the fibrous filler, the platy filler, the granular filler and the liquid crystal polyester.

Examples of such other components include ordinary additives including mold release improving agents, such as fluororesins and metal soaps; coloring agents, such as dyes and pigments; antioxidants; heat stabilizers; UV absorbers; antistatic agents; and a surfactants. Carbon black is preferred as a coloring agent.

Further examples of the other components include substances with an external lubricant effect, such as higher fatty acids, higher fatty acid esters, higher fatty acid metal salts, and fluorocarbon-based surfactants.

Further examples of the other components include thermoplastic resins, such as polyamides, polyesters other than liquid crystal polyesters, polyphenylene sulfides, polyetherketones, polycarbonates, polyphenylene ethers and their modified versions, polysulfones, polyethersulfones, and polyetherimides; and thermosetting resins, such as phenol resins, epoxy resins, and polyimide resins.

The liquid crystal polyester composition of the present invention contains the aforementioned fibrous filler, platy filler, granular filler, and liquid crystal polyester preferably in an amount in total of 35% by mass or more, more preferably 45% by mass or more where the overall amount of the liquid crystal polyester composition is considered to be 100% by mass; the composition may contain only the fibrous filler, platy filler, granular filler, and liquid crystal polyester. By adjusting the combined content to 35% by mass or more, melt flowability in molding becomes more increased and resistance to the rupture of a lattice after molding is improved more.

The liquid crystal polyester composition of the present invention can be produced by compounding raw material components, and the compounding method is not particularly restricted. One example is a method in which the aforementioned fibrous filler, platy filler, granular filler, liquid crystal polyester, and optionally the aforementioned other components are fed individually separately to a melt mixer. It is also possible to feed these raw material components to a melt mixer after preliminarily mixing them using a mortar, a Henschel mixer, a ball mill or a ribbon blender. It is also possible to mix pellets prepared by melt-mixing a liquid crystal polyester and a fibrous filler, pellets prepared by melt-mixing a liquid crystal polyester and a platy filler, and pellets prepared by melt-mixing a liquid crystal polyester and a granular filler in a desired mixing ratio.

The liquid crystal polyester composition of the present invention is superior in melt flowability at the time of molding and it is suitable for the production of molded articles with high mechanical strength. The method for producing a molded article may be conventional methods such as injection molding. In particular, a connector obtained by molding the liquid crystal polyester composition of the present invention exhibits high resistance to warpage or rupture of a lattice even if it is thin.

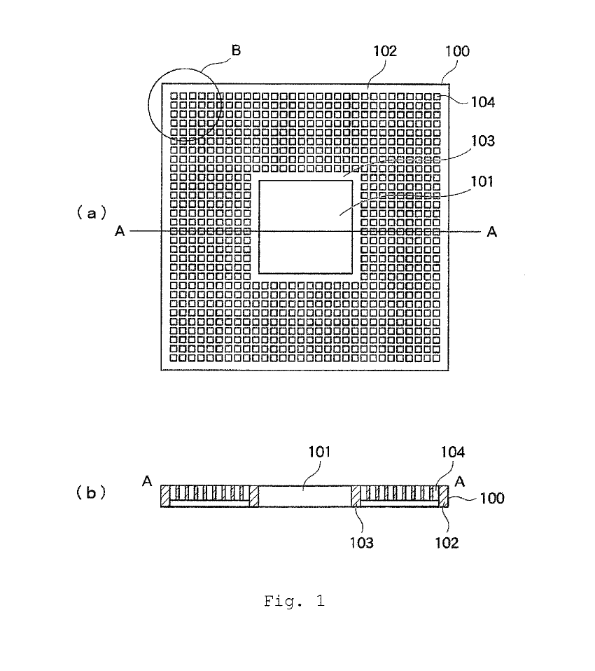

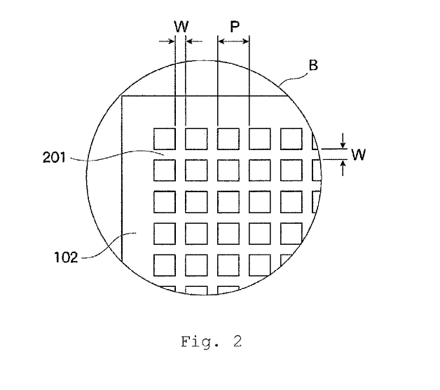

FIG. 1 is a schematic view illustrating a connector obtained by molding a liquid crystal polyester composition of the present invention; (a) is a plan view and (b) is a sectional view taken along the A-A line of (a). FIG. 2 is an enlarged view of region B in FIG. 1(a).

The connector 100 depicted here is a CPU socket, which is in a square plate-like shape in a plane view and has a square opening 101 in the central portion. The outer peripheral part and the inner peripheral part of the connector 100 have been formed with the rear surfaces projecting and form an outer frame portion 102 and an inner frame portion 103, respectively. In the area surrounded by the outer frame portion 102 and the inner frame portion 103, 794 pin insertion holes 104, whose horizontal section is square in shape, are formed in a matrix form. As a result, the shape of the portion which partitions the pin insertion holes 104 each other, i.e., a minimum thickness portion 201 is entirely a lattice-like shape.

Although the size of the connector 100 may be set arbitrarily according to the intended purpose, for example, the outer dimensions are 42 mm×42 mm and the dimensions of an opening 101 are 14 mm×14 mm. The thickness of the connector 100 is 4 mm at the outer frame portion 102 and the inner frame portion 103, and the thickness is 3 mm in the area surrounded by these frames (i.e., the thickness of the minimum thickness portion 201). The pin insertion hole 104 has a sectional dimension of 0.7 mm×0.7 mm and a pitch P of 1 mm. The width of the minimum thickness portion 201 (i.e., the thickness of the wall of a lattice) W is 0.3 mm. The dimensions shown herein are examples and the number of pin insertion holes 104 also may be determined arbitrarily according to the intended purpose.

When producing the connector 100 by injection molding, conditions therefor preferably include a molding temperature of 300 to 400° C., an injection speed of 100 to 300 mm/sec, and an injection peak pressure of 50 to 150 MPa.

### EXAMPLES

The present invention is described in detail below with reference to examples. However, the present invention is not limited to the following examples. The flow onset temperature of a liquid crystal polyester was measured by the following method.

### Measurement of Flow Onset Temperature of Liquid Crystal Polyester

Using a Flow Tester (“Model CFT-500”, manufactured by Shimadzu Corporation), about 2 g of a liquid crystal polyester was filled into a cylinder attached with a die including a nozzle having an inner diameter of 1 mm and a length of 10 mm, and the liquid crystal polyester was melted while raising the temperature at a rate of 4° C./minute under a load of 9.8 MPa (100 kg/cm²), extruded through the nozzle, and then the temperature at which a viscosity of 4,800 Pa·s (48,000 poise) was exhibited was measured.

### Reference Example 1

### Production of Liquid Crystal Polyester

In a reactor equipped with a stirrer, a torque meter, a nitrogen gas introducing tube, a thermometer, and a reflux condenser, 994.5 g (7.2 mol) of p-hydroxybenzoic acid, which would become repeating unit (A1), 446.9 g (2.4 mol) of 4,4′-dihydroxybiphenyl, which would be come repeating unit (C1), 299.0 g (1.8 mol) of terephthalic acid which would become repeating unit (B1), 99.7 g (0.6 mol) of isophthalic acid, which would become repeating unit (B2), and 1347.6 g (13.2 mol) of acetic anhydride were charged. Therefore, the molar ratios of repeating units include a repeating unit (C1)/repeating unit (A1) ratio of about 0.3, a {repeating unit (B1)+repeating unit (B2)}/repeating unit (C1) of 1.0, and a repeating unit (B2)/repeating unit (B1) ratio of about 0.3.

After the atmosphere inside the reactor was sufficiently replaced with nitrogen gas, 0.18 g of 1-methylimidazole was added, followed by raising temperature to 150° C. over 30 minutes under a nitrogen gas flow, and further refluxing for 30 minutes while maintaining at that temperature (150° C.).

Then, after adding 2.4 g of 1-methylimidazole, the temperature was raised to 320° C. over 2 hours and 50 minutes while distilling off the by-product acetic acid thus distilled out and the unreacted acetic anhydride. Thereafter, the time at which an increase in torque was recognized was considered as the completion of the reaction and contents were taken out of the reactor.

Subsequently, the contents (solid) thus obtained were cooled to room temperature, crushed by a coarse crusher and then subjected to solid phase polymerization under a nitrogen gas atmosphere by raising the temperature from room temperature to 250° C. over 1 hour, further from 250° C. to 295° C. over 5 hours, and then maintaining the temperature at 295° C. for 3 hours.

Then, the resultant was cooled, whereby a liquid crystal polyester (LCP1) was obtained. The flow onset temperature of this liquid crystal polyester was 327° C.

### Reference Example 2

### Production of Liquid Crystal Polyester

In a reactor equipped with a stirrer, a torque meter, a nitrogen gas introducing tube, a thermometer, and a reflux condenser, 994.5 g (7.2 mol) of p-hydroxybenzoic acid, which would become repeating unit (A1), 446.9 g (2.4 mol) of 4,4′-dihydroxybiphenyl, which would be come repeating unit (C1), 239.2 g (1.44 mol) of terephthalic acid which would become repeating unit (B1), 159.5 g (0.96 mol) of isophthalic acid, which would become repeating unit (B2), and 1347.6 g (13.2 mol) of acetic anhydride were charged. Therefore, the molar ratios of repeating units include a repeating unit (C1)/repeating unit (A1) ratio of about 0.3, a {repeating unit (B1)+repeating unit (B2)}/repeating unit (C1) of 1.0, and a repeating unit (B2)/repeating unit (B1) ratio of about 0.7. That is, in this Production Example, the repeating unit (B2)/repeating unit (B1) ratio is about twice that of Production Examples 1.

After the atmosphere inside the reactor was sufficiently replaced with nitrogen gas, 0.18 g of 1-methylimidazole was added, followed by raising temperature to 150° C. over 30 minutes under a nitrogen gas flow, and further refluxing for 30 minutes while maintaining at that temperature (150° C.)

Then, after adding 2.4 g of 1-methylimidazole, the temperature was raised to 320° C. over 2 hours and 50 minutes while distilling off the by-product acetic acid thus distilled out and the unreacted acetic anhydride. Thereafter, the time at which an increase in torque was recognized was considered as the completion of the reaction and contents were taken out of the reactor.

Subsequently, the contents (solid) thus obtained were cooled to room temperature, crushed by a coarse crusher and then subjected to solid phase polymerization under a nitrogen gas atmosphere by raising the temperature from room temperature to 220° C. over 1 hour, further from 220° C. to 240° C. over 0.5 hours, and then maintaining the temperature at 240° C. for 10 hours.

Then, the resultant was cooled, whereby a liquid crystal polyester (LCP2) was obtained. The flow onset temperature of this liquid crystal polyester was 286° C., which was 41° C. lower than the flow onset temperature of LCP1.

### Example 1

LCP1, LCP2, a filler, and other components were compounded together in the proportions given in Table 1, followed by pelletization at a cylinder temperature of 340° C. using a twin screw extruder (“PCM-30” manufactured by Ikegai Iron Works, Ltd.), whereby a pelletized liquid crystal polyester composition was obtained.

Subsequently, using the resulting liquid crystal polyester composition, injection molding was carried out under the following injection molding conditions, whereby a CPU socket illustrated in FIGS. 1 and 2 was produced.

Injection molding machine: “ROBOSHOT S-2000i 30B” manufactured by FANUC LTD.

Cylinder temperature: 350° C.

Mold temperature: 70° C.

Injection speed: 200 mm/sec

### Examples 2 to 4 and Comparative Examples 1 to 3

Pelletized liquid crystal polyester compositions and CPU sockets were produced in the same manner as Example 1 except that the compounded ratios of the respective components were adjusted as given in Table 1.

The fillers and other components used in Examples and Comparative Examples are as follows.

### (1) Fibrous Filler

Glass fiber (A): CSO3JAPX-1 (produced by ASAHI FIBER GLASS Co., Ltd.), average fiber diameter=10 μm, number average fiber length=325 μm (Example 1), 331 μm (Example 2), 301 μm (Example 4), 336 μm (Comparative Example 1), 304 μm (Comparative Example 2), 296 μm (Comparative Example 3)

Glass fiber (B): EFH75-01 (produced by CENTRAL GLASS Co., Ltd.), average fiber diameter=10 μm, number average fiber length=81 μm (Example 3)

### (2) Platy Filler

Talc: MS-KY (produced by NIPPON TALC Co., Ltd.), volume average particle diameter=14.2 μm

### (3) Granular Filler

Glass beads: EGB731 (produced by Potters-Ballotini Co., Ltd.), volume average particle diameter=11.3 μm

### (4) Other Components

Carbon black: CB#45 (produced by Mitsubishi Chemical Corporation)

Dipentaerythritol hexastearate: LOXIOL VPG2571 (produced by Cognis Oleochemicals Japan Ltd.)

For the liquid crystal polyester compositions and connectors obtained above, the following characterization evaluations were carried out. The results are shown in Table 1.

### Rupture Strength of Lattice of Connector

The rupture strength of the lattice of a CPU socket was measured under the following measurement conditions by using a precision universal tester (manufactured by Aikoh Engineering Co., Ltd.).

Span length: 20 mm

Test speed: 6 mm/min

Tip: A ballpoint probe was used.

### Filling Pressure of Liquid Crystal Polyester Composition

The injection peak pressure at the time of molding a connector was measured and defined as a filling pressure.

TABLE 1

| | Example | | | | Comparative Example | | |
|---|---|---|---|---|---|---|---|
| | 1 | 2 | 3 | 4 | 1 | 2 | 3 |
| Compounded | | | | | | | |
| components | | | | | | | |
| (part(s) by mass) | | | | | | | |
| LCP1 | 30.25 | 30.25 | 30.25 | 24.75 | 30.25 | 30.25 | 22 |
| LCP2 | 24.75 | 24.75 | 24.75 | 20.25 | 24.75 | 24.75 | 18 |
| (1) Glass fiber | | | | | | | |
| Glass fiber (A) | 15 | 13 | 0 | 5 | 11.2 | 16.2 | 15 |
| Glass fiber (B) | 0 | 0 | 15 | 0 | 0 | 0 | 0 |
| (2) Talc | 15 | 15 | 15 | 5 | 18.8 | 18.8 | 25 |
| (3) Glass beads | 15 | 13 | 15 | 45 | 15 | 10 | 20 |
| Carbon black | 1 | 1 | 1 | 1 | 1 | 1 | 1 |
| Dipentaerythritol | 0.3 | 0.3 | 0.3 | 0.3 | 0.3 | 0.3 | 0.3 |
| hexastearate | | | | | | | |
| (1) + (3) | 30 | 26 | 30 | 50 | 26.2 | 26.2 | 35 |
| (1) + (2) + (3) | 45 | 41 | 45 | 55 | 45 | 45 | 60 |
| Proportion | | | | | | | |
| (2)/{(1) + (3)} | 0.50 | 0.58 | 0.50 | 0.09 | 0.72 | 0.72 | 0.71 |
| Evaluation result | | | | | | | |
| Filling pressure | 83 | 75 | 72 | 138 | 77 | 84 | 170 |
| (MPa) | | | | | | | |
| Rupture strength | 93 | 92 | 89 | 89 | 84 | 86 | 95 |
| (N) | | | | | | | |

As is clear from Table 1, the liquid crystal polyester compositions of Examples 1 to 4 were low in filling pressure and superior in melt flowability and incomplete filling thereof was inhibited. In addition, the connectors of Examples 1 to 4 were high in rupture strength of a lattice.

Conversely, the connectors of Comparative Examples 1 and 2 were low in the rupture strength of a lattice, and the liquid crystal polyester composition of Comparative Example 3 was high in filling pressure and insufficient in melt flowability.

liquid crystal polyester composition of the present invention can be used for the production of connectors for electronic components.

What is claimed is:

1. A liquid crystal polyester composition comprising a fibrous filler, a platy filler, a granular filler, and a liquid crystal polyester, wherein the content of the platy filler is not more than 0.6 where the combined content (based on mass) of the fibrous filler and the granular filler is considered to be 1.

2. The liquid crystal polyester composition according to claim 1, wherein the combined content of the fibrous filler, the platy filler, and the granular filler is not more than 50% by mass where the overall amount of the liquid crystal polyester composition is considered to be 100% by mass.

3. The liquid crystal polyester composition according to claim 1, wherein the content of the fibrous filler is 5 to 80 parts by mass where the content of the liquid crystal polyester is considered to be 100 parts by mass.

4. The liquid crystal polyester composition according to claim 1, wherein the content of the platy filler is 5 to 80 parts by mass where the content of the liquid crystal polyester is considered to be 100 parts by mass.

5. The liquid crystal polyester composition according to claim 1, wherein the content of the granular filler is 5 to 80 parts by mass where the content of the liquid crystal polyester is considered to be 100 parts by mass.

6. The liquid crystal polyester composition according to claim 1, wherein the average fiber diameter of the fibrous filler is 5 to 20 μm and the number average fiber length of the fibrous filler is not less than 100 μm.

7. The liquid crystal polyester composition according to claim 1, wherein the volume average particle diameter of the platy filler is 10 to 100 μm.

8. The liquid crystal polyester composition according to claim 1, wherein the volume average particle diameter of the granular filler is 10 to 100 μm.

9. The liquid crystal polyester composition according to claim 1, wherein the liquid crystal polyester contains repeating units represented by the following formula (A1) in an amount of not less than 30 mol % where the total amount of all repeating units constituting the liquid crystal polyester is considered to be 100 mol %:

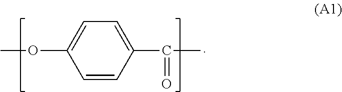

10. A connector made of the liquid crystal polyester composition according to claim 1.
